(19) United States
(12) Patent Application Publication
(10) Pub. No.: US 2006/0114642 A1
(43) Pub. Date: Jun. 1, 2006

(54) Systems and methods for integrated VAR compensation and hydrogen production

(76) Inventors: Yan Liu, Niskayuna, NY (US); Luis Jose Garces, Niskayuna, NY (US); Rajib Datta, Albany, NY (US)

Correspondence Address: Patrick S. Yoder;FLETCHER YODER, P.O. Box 692289, Houston, TX, 77269-2289, US

(21) Appl. No.: 11/000,470

(22) Filed: Nov. 30, 2004

(51) Int. Cl. H01G 9/00

(52) U.S. Cl. 361/500

(57) ABSTRACT

A method for regulating power in a grid is disclosed. The method involves generating a controllable DC power to an electrolyzer via power conversion circuitry to produce hydrogen. The method further involves providing a controllable reactive power to the grid via the power conversion circuitry to regulate power in the grid.

### BACKGROUND

The invention relates generally to the field of electrical transmission and distribution systems. More specifically, this invention relates to power systems used for regulating transmission of electrical power.

Electrical power is generated at various types of power generating stations and is fed into a power grid to supply and meet the demands of domestic, industrial and commercial consumers. Power distribution stations handle the transmission and distribution of electrical power from the power generating stations to the ultimate users. Typically, the demand for electrical power from various types of consumers varies, though in a somewhat predictable manner. The industrial and commercial consumers, typically, require more electrical power during the day while the domestic consumers require more electrical power during morning and evening hours. Even with such differentiation among users, there are frequent instances of voltage surges or collapses resulting in undesired effects at both the suppliers' end and at the consumers' end.

Reactive power is the part of the apparent power (VA) that must be necessarily produced in an alternative current (AC) system for the electrical power generation, transmission and distribution. Electric motors, electromagnetic generators and alternators used for creating or consuming alternating current are all components of the AC electrical energy delivery chain that require reactive power. Reactive power is defined as a product of root-mean-square (RMS) voltage, current, and the sine of the difference in phase angle between the RMS voltage and the current phasor. Reactive power is commonly referred to in terms of units of volt-amperes reactive and denoted as “VAR”.

Reactive power is associated with reactance of the load, generator or transmission means and can be positive or negative depending on the aforementioned phase angle. A purely capacitive impedance contributes to a positive reactive power while a purely inductive impedance contributes to a negative reactive power. In an AC transmission system, it is typically desired to keep the magnitude of the reactive power to the minimum required for the transport of the active power from the generator to the user. Transmission lines that carry a large reactive power will also carry an AC current of large amplitude. This large amplitude AC current will generate undesired resistive losses in the power cable and will tend to reduce the amplitude of the voltage at the terminal of the end user. Reactive power may be controlled by actively reducing the phase angle between the RMS voltage and current phasor. This is usually done by adding a capacitive load if the phase angle is too negative or vice versa.

For a given line impedance, the amount of reactive power required is roughly proportional to the amount of active power that the line is transmitting. Since demand for power varies considerably with time, the reactive power in a transmission line varies as well. Inclusion of a VAR compensation scheme on to a transmission network may be useful for a variety of reasons, such as to reduce transmission line losses, increasing the transmission capacity, to improve voltage control, and to increase transient stability. Modern active VAR compensators make use of power electronics blocks employing silicon controlled rectifier assemblies. The assemblies comprise a static switch with passive reactive power sources, such as a capacitor for example.

These power switches are dedicated only to the controlled generation of VARS and do not connect directly to the end user. Therefore there is a need for a variant of VAR generation, where electronic blocks with active switches serves a dual function, namely the voltage regulation by the active generation of reactive power of capacitive and inductive nature and the regulated feeding of active power to an end user.

### BRIEF DESCRIPTION

In accordance with one aspect of the present technique, a method for regulating power in a grid is disclosed. The method involves generating a controllable DC power to an electrolyzer via power conversion circuitry to produce hydrogen. The method further involves providing a controllable reactive power to the grid via the power conversion circuitry to regulate power in the grid.

In accordance with another aspect of the present technique, a method for regulating power is disclosed. The method involves converting an alternating current AC power to a DC power via one or more converters and using the DC voltage to produce hydrogen by electrolysis. The method also involves generating a controllable reactive power by controlling operation of the one or more converters and the electrolysis to regulate the power.

In accordance with yet another aspect of the present technique, a system for regulating power in a grid is disclosed. The system includes an electrolyzer for producing hydrogen and a power conversion circuitry coupled to the grid and the electrolyzer. The power conversion circuitry is adapted to supply a controllable DC power to the electrolyzer and a controllable reactive power to the grid.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an exemplary system for VAR regulation in a power transmission and distribution system using an electrolyzer in accordance with certain aspects of the present technique;

FIG. 2 illustrates an exemplary system for VAR regulation in a power transmission and distribution system using a DC load in accordance with certain aspects of the present technique;

FIG. 3 is a diagrammatical illustration of an exemplary power converter unit using a bulk converter;

FIG. 4 is a diagrammatical illustration of an exemplary power converter unit using a modular converter in accordance with certain aspects of the present technique;

FIG. 5 is a diagrammatical illustration of an exemplary power converter unit using a current source inverter in accordance with certain aspects of the present technique;

FIG. 6 is a schematic illustration of an exemplary bulk converter topology in accordance with certain aspects of the present technique;

FIG. 7 is a schematic illustration another exemplary bulk converter topology in accordance with certain aspects of the present technique;

FIG. 8 is a schematic illustration exemplary modular inverter topology in accordance with certain aspects of the present technique;

FIG. 9 is a schematic illustration exemplary DC chopper topology in accordance with certain aspects of the present technique;

FIG. 10 is a schematic illustration an exemplary current source inverter topology in accordance with certain aspects of the present technique; and

FIG. 11 is a schematic illustration exemplary filter circuit in accordance with certain aspects of the present technique.

### DETAILED DESCRIPTION

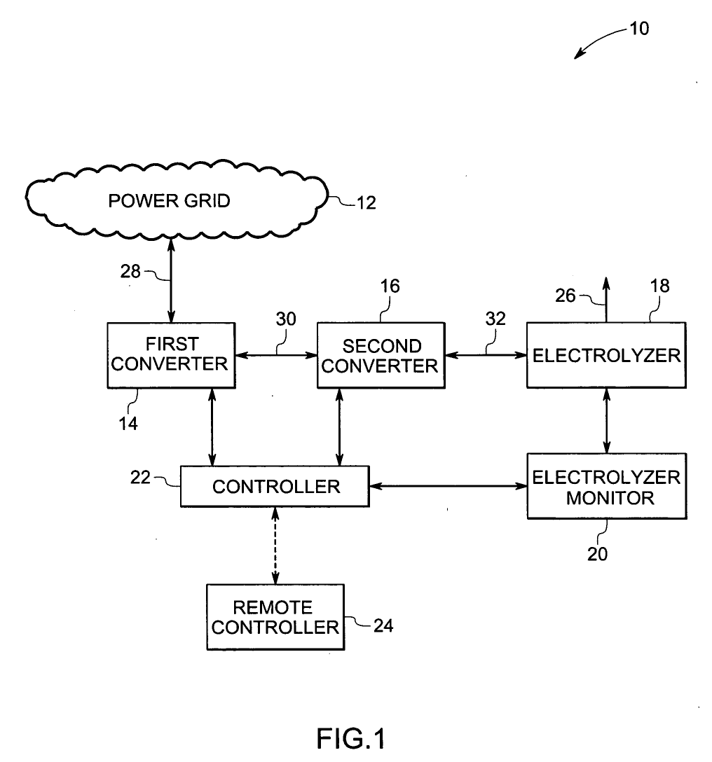

Turning now to the drawings and referring first to FIG. 1, an exemplary system 10 for regulating static VAR in a power grid 12 is illustrated. The exemplary system 10 includes a first converter 14, a second converter 16, an electrolyzer 18, an electrolyzer monitor 20, a controller 22, and a remote controller 24.

As illustrated in FIG. 1, the first converter 14 is electrically coupled to the power grid 12, and to the second converter 16. The second converter 16 is coupled to the electrolyzer 18 that is in turn coupled to an electrolyzer monitor 20. The controller 22 is electrically coupled to the first converter 14, the second converter 16, and to the electrolyzer monitor 20, and performs the tasks of monitoring and controlling the first converter 14, the second converter 16 and the electrolyzer monitor 20. The electrolyzer monitor 20 monitors the electrolyzer 18 for the amount of hydrogen 26 produced by the electrolyzer 18. In certain implementations, the controller 22 may be coupled to a remote controller 24 that controls, monitors and alters the function of the controller 22. The remote controller 24 is particularly useful when the exemplary system 10 is located at a remote location. Functions of each of the aforementioned components will be discussed in greater detail below. In certain other implementations of the present technique, voltage from the power grid 12 may also be fed to the controller 22. In such cases, the controller 22 will monitor and regulate changes in the magnitude of the voltage and current vectors at the output of the first converter.

It must also be particularly noted that, in the present technique, a single power conversion circuitry is being employed to facilitate the supply of a controllable DC power from the power grid 12 to the electrolyzer 18 as well as the supply of a controllable reactive power from the electrolyzer 18 to the power grid 12. The power conversion circuitry, in the illustrated embodiment, includes the first converter 14 and the second converter 16. However, in certain other exemplary embodiments of the present technique; the power conversion circuitry may include just one converter to facilitate the conversion of AC to DC as appropriately required by the electrolyzer or any other DC load.

The first converter 14, as described herein, draws power at an AC voltage 28 from the power grid 12. The first converter 14, then suitably converts the AC voltage 28 into a first DC voltage 30. The second converter 16 then converts the first DC voltage 30 to a second DC voltage 32. The reasons for converting the first DC voltage to the second DC voltage include a need to accurately regulate the current fed into the load and also to isolate the electrolyzer from the power grid 12 during extreme operating conditions. The electrolyzer 18 operates at the second DC voltage 32 to produce hydrogen 26. In certain other exemplary embodiments of the present technique, the power grid 12 may include a step-down transformer to convert a primary AC voltage to a secondary AC voltage of lower amplitude and the first converter 14 draws this secondary AC voltage to convert it into the first DC voltage 30. Under operating conditions, the power converter 10 may deliver a controllable reactive power to the power grid 12 while at the same time, producing hydrogen 26 that may be utilized for useful purposes, for example, as a fuel for hydrogen-based vehicles or as a fuel to operate the fuel cells to generate electricity. A detailed description and possible embodiments of the various converters is provided below.

In principle, an electrolyzer may be thought of as a reverse fuel cell. For instance, while a fuel cell takes as input hydrogen and oxygen to produce a DC power, and water as a byproduct, the electrolyzer takes as input water and electricity (in the form of a DC voltage applied between electrodes located within the electrolyzer) to generate hydrogen and oxygen. While there are various different constructions of electrolyzers, in its simplest form the electrolyzer consists of two vertical hollow tubes connected by a horizontal tube to form a U-shaped apparatus. The U-shaped apparatus contains water mixed with sodium hydroxide or any other suitable chemicals. Attached to each of the bottom portions of the vertical hollow tubes are electrodes to which the DC voltage is applied. On passage of electricity, the water is electrolyzed into its primary components, i.e., hydrogen and oxygen. The hydrogen is collected from the vertical tube to which the positive polarity of the DC voltage is applied while oxygen is collected from the other vertical tube. Furthermore, to facilitate the operation of the electrolyzer for commercial applications, the electrolyzers typically require voltage conversion circuitry to transform commonly available AC voltage supply to a required DC voltage supply. In the present technique, the power converter 10 enables the supply of controlled DC power to the electrolyzer for production of hydrogen while also providing the power grid 12 with controllable reactive power acting as a VAR compensator.

As would be appreciated by those skilled in the art, power transmission and distribution systems have to continuously cope with disturbances associated with variable power demand and a less variable active power production. Power production is regulated to avoid imbalance with power demand. Regulation of the user terminal voltage is typically associated with power factor correction, VAR compensation and voltage regulation. Traditionally VAR (reactive power) compensation has been achieved by employing static switching blocks that contain one or more forms of passive reactive power sources. Examples of passive reactive power sources include capacitors and inductors. Capacitors may be used to contribute positive reactive power, while inductors may be used to contribute negative reactive power.

In a DC powered circuit, the active power in the circuit is defined as the instantaneous product of voltage and current in the circuit. In an AC powered circuit, average active power may be defined as a product of instantaneous apparent power and the cosine of the angle between the current and the voltage in the circuit. The latter term is generally referred to as the power factor. Most transmission and distribution networks transmit power as AC power. In order to maximize the amount of active power transmitted from the generating station to the end user there is a conscientious effort to keep the power factor close to unity at all times. If the power factor is not optimally reduced, a current of larger amplitude has to be generated for the same active power delivered to the users due to the transmission and distribution line reactive nature.

Voltage regulation is typically provided at the sub-station level to maintain steady voltages at the user terminals at desired levels. Ideally, the voltage delivered via an AC transmission and distribution system should be constant in amplitude and frequency. However, in practice, the voltage may vary somewhat. In certain exemplary cases, voltage may vary due to fluctuations at the production end. In other exemplary cases, the voltage may vary due to variations in demand.

Continuing with the discussion on FIG. 1, the exemplary power converter 10 provides for VAR compensation and powers the electrolyzer 18 to produce hydrogen. In certain exemplary implementations of the present technique, an electrolyzer monitor 20 may monitor the electrolyzer 18 to track the amount of hydrogen produced. Reasons for monitoring the electrolyzer 18 include an inability of the electrolyzer to operate or produce hydrogen below a certain applied load condition. In certain other exemplary embodiments of the present technique, the electrolyzer monitor 20 may also control the amount of hydrogen produced by controlling the current supplied to the electrolyzer from the second controller 16. The electrolyzer monitor 20 is, in turn, controlled and monitored by a controller 22. The controller 22 is typically overseen by a system operator who also monitors interaction of the circuitry with the power grid 12.

In certain other embodiments of the present technique, the exemplary power converter 10 may be monitored remotely by a system operator via a remote controller 24. This is particularly helpful when the power converter is located at a remote sub-station, and where the cost and efforts of situating a system operator on-site becomes uneconomical or otherwise unfeasible. The remote controller 24 may communicate to the controller 22 located in the power converter 10 via wired or wireless communication. Wireless communication may include microwave communication, optical “line-of-sight” communication, radio-frequency communication or any other suitable form of communication. The generated hydrogen 26 may be stored in tanks or suitable storage vessels, and collected and transported for use in fuel cells for production of electricity for local, sub-station consumption, in applications such as lighting and auxiliary power supply. The hydrogen 26 generated by the electrolyzer 18 may also be used as a fuel for hybrid vehicles, or any of a range of other applications.

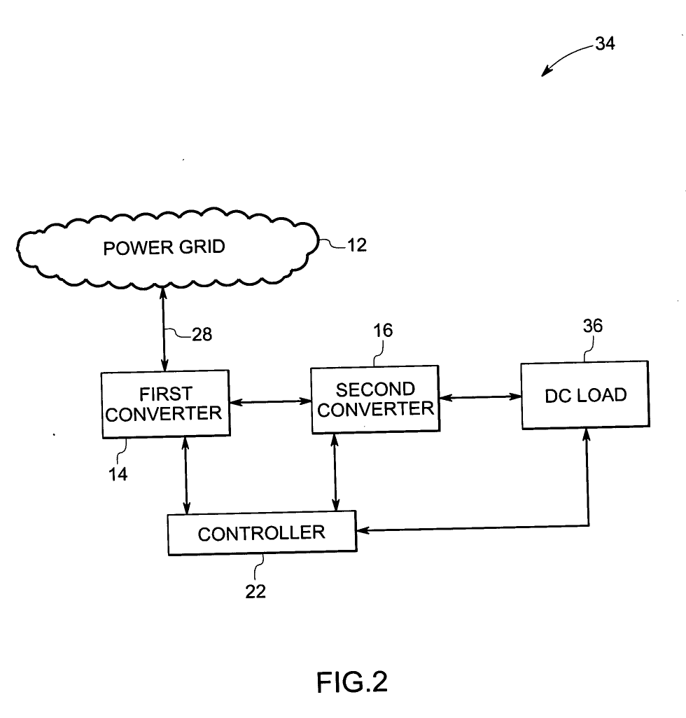

FIG. 2 illustrates another exemplary power converter 34 for regulating reactive power in a power transmission and distribution system 12 using any generic DC load 36. Apart from the DC load being an electrolyzer (as illustrated in FIG. 1), other examples of DC active or passive loads include fuel cells, photovoltaic assemblies, wind turbines, or any other appropriate DC load that may be employed to generate useful work during normal operating conditions of the power grid 12. In certain other embodiments of the present technique, it is also possible to have a combination of these DC active loads to produce useful work or energy. For example, the electrolyzer could be coupled to a fuel cell assembly, where the hydrogen produced by the electrolyzer is used to produce electricity.

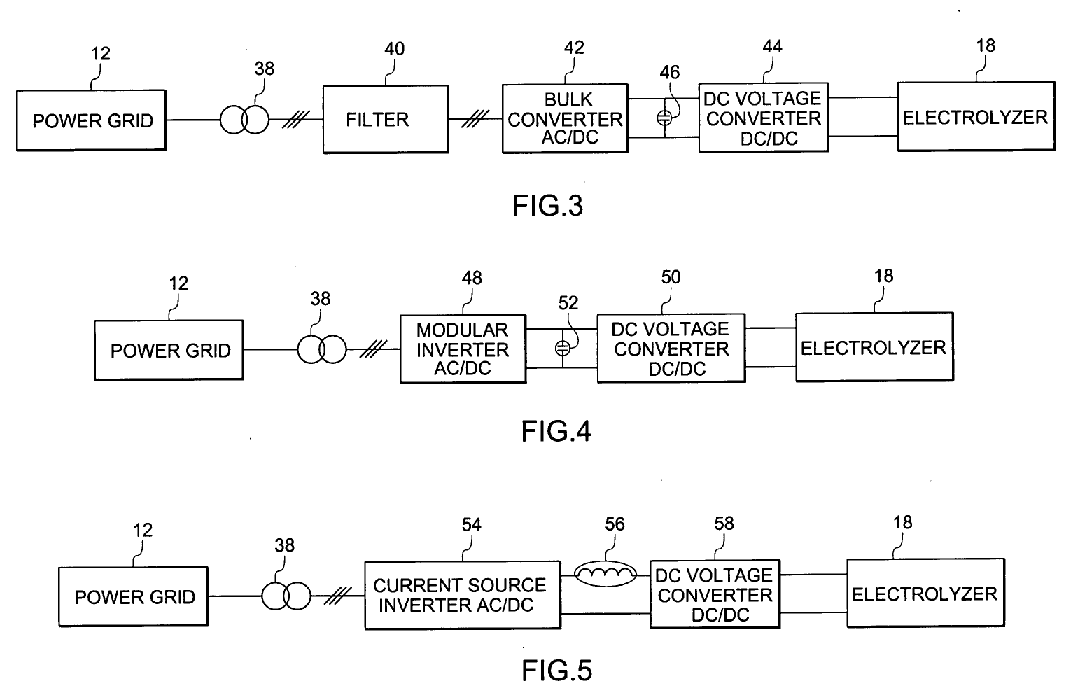

FIG. 3 illustrates one embodiment of the present technique that provides VAR compensation using an electrolyzer 18 (as illustrated in FIG. 1). In the illustrated embodiment, a transformer 38 is used to step-down the voltage from the power grid 12 to a useable level. In the present embodiment, the transformer 38 has single primary and secondary windings. It should be noted that power fed into the power grid 12 may include harmonics that could cause what is typically termed “harmonic pollution”. Apart from causing the harmonic pollution, the harmonics also increase the ohmic losses without contributing to the useful active power transmission. One or more active filters 40 may be employed to reduce harmonics and also to provide additional reactive power compensation. The active filter 40 monitors the current coming from the converter, and generates a controlled current that cancels said harmonics, and provides smoothed current to the power grid. Advantages of using active filters for filtering harmonics include their smaller size as compared to passive filters, the reduction of problems associated with resonance in the transmission lines, fast response and their ability to significantly reduce most of the harmonic components from the current fed into the power grid 12.

In the present embodiment, the bulk AC-DC converter 42 (comparable to the first converter 14 of FIG. 1) converts the AC power to a first DC power. Because in the presently contemplated embodiment, the power grid 12 provides 3-phase AC, a 3-phase, full-wave bridge active rectifier is used. A DC voltage converter 44 (comparable to the second converter 16 of FIG. 1) converts the first DC power to a second DC power. The DC voltage converter 44 may be referred to as a “voltage chopper”. In general, chopper circuits may typically be classified into two types, i.e., step down choppers and step up choppers. One suitable chopper circuit topology will be discussed in greater detail below. A DC link capacitor 46 is coupled between the bulk converter 42 and the DC voltage converter 44. The DC link capacitor is required to reduce the voltage ripple generated by both converters serving at the same time, as reactive power source for the system. It should be noted that the DC voltage converter 44 provides a controlled current to the electrolyzer 18 for hydrogen production.

FIG. 4 illustrates another embodiment of the present technique for providing VAR compensation where a modular inverter 48 (comparable to the first converter 14 of FIG. 1) is coupled to the power grid 12 via the transformer 38. In the present embodiment, the transformer 38 has multiple secondary windings. The modular inverter 48 permits multiple inverter units of smaller size to be utilized in transforming the AC voltage into DC. The multiple secondary windings on the transformer 38 are used to power the individual inverter modules in the modular inverter 48. Due to the modular design, the resulting system is less vulnerable to single point failures. If one of the small inverters were to fail due to over-current or for other reason, it can be disconnected while the rest of the system will be still capable to operate with a reduced level of performance. This is not the case in the previously described system using a large single bulk converter. The modular inverter 48 can also significantly reduce the amplitude of the harmonic voltages fed to the power grid 12 without the use of any active or passive filter (as illustrated in FIG. 3). An exemplary modular inverter topology is described below. The modular inverter 48 is coupled to a DC voltage converter 50. The DC converter 50 operates in a manner similar to the DC converter 44 described above and illustrated in FIG. 3

FIG. 5 illustrates yet another embodiment of the present technique wherein a current source inverter 54 (comparable to the first converter 14 as illustrated in FIG. 1) is used to convert the AC voltage to a regulated DC current. The grid side converter fed a DC link with a relatively large inductance, becoming a current source. The inductance has a similar role as the DC link capacitor in the previously described converters, filtering the current ripple in the DC bus and being the source of reactive power for the system. Such current source inverters are also very rugged, and even in the event of a short circuit of the DC bus, its current should still remain under control by regulating the voltage of the converter not short-circuited. The storage element for the current source inverter in the illustrated embodiment is the DC link inductor 56, which is placed on the DC side of the current source inverter 54. The DC converter 58 that is coupled to the electrolyzer 18 operates in a manner similar to the DC converter 44, described above with its output current being equal in amplitude to the current in the DC link inductor.

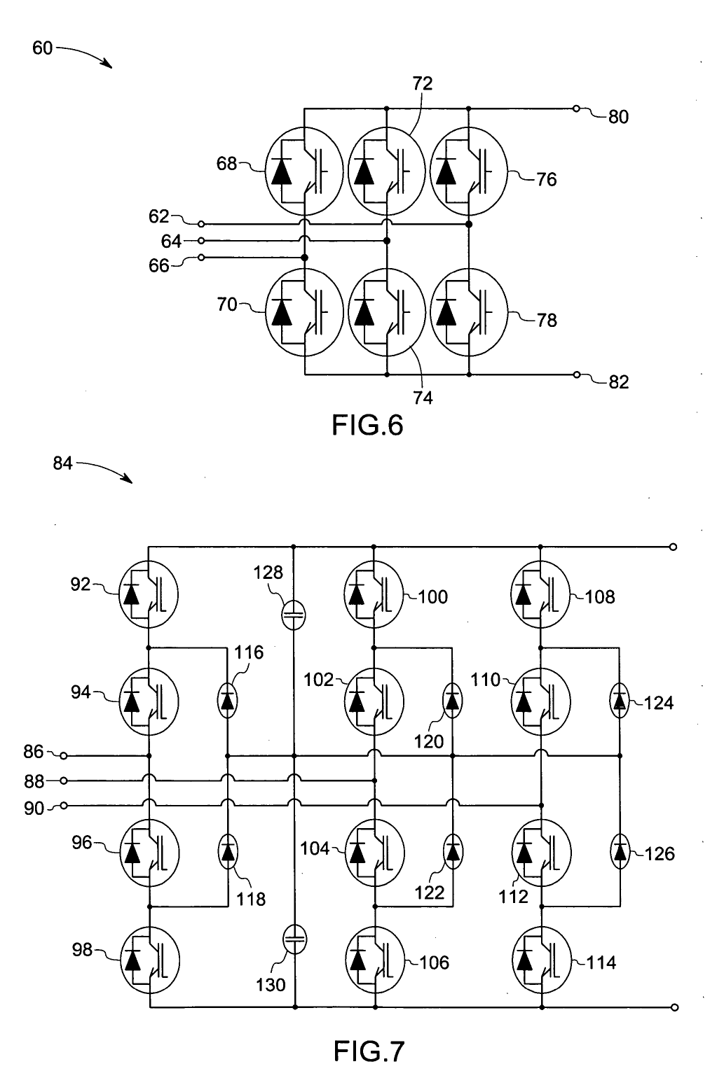

FIG. 6 illustrates one exemplary embodiment of the bulk converter topology 60 for the bulk converter 42 illustrated in FIG. 3. As explained earlier, the bulk converter 42 follows a full-wave bridge active rectifier topology. It should be noted that in a presently contemplated embodiment, the bulk converter topology is configured for a 3-phase application, designed to operate with a 3-phase power grid 12. Each phase line, indicated by reference numerals 62, 64, and 66, is coupled between a pair of transistor modules 68 and 70, 72 and 74, and 76 and 78, respectively: one to route power to the positive side 80 of the load, and the other to route power to the negative side 82 of the load. The load in this case is the DC voltage converter 54 and the electrolyzer 18.

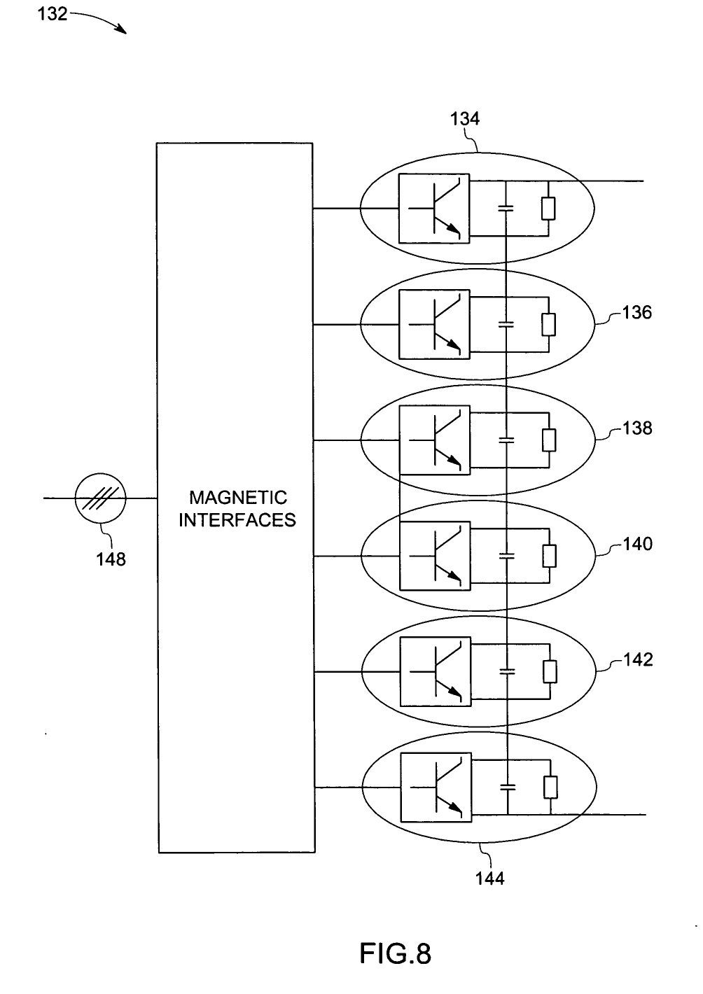

FIG. 7 illustrates another exemplary embodiment of the bulk converter topology 84 for the bulk converter 42 illustrated in FIG. 3. Inputs to the present embodiment of the bulk converter 84 are provided via input points designated by reference numerals 86, 88, and 90. Unlike the two level active bridge rectifiers, the present embodiment illustrates a 3-level converter that uses transistor-switching blocks 92 through 114. Converters using three level technology have been previously known in the art. In certain operating conditions, the present embodiment provides greater freedom for use in high-voltage applications, to generate current with fewer ripples and harmonics. Other advantages of using the exemplary embodiment include reduced switching losses, reduced common mode currents, and reduced electromagnetic compatibility (EMC) problems among other things. In the presently illustrated embodiment, the switches have to only commutate between half of the total DC link voltage as compared with the two-level converter where switching is done across the full link voltage. EMC may be defined as the ability of an equipment, sub-system or system to share the electromagnetic spectrum, and perform their desired function without unacceptable degradation from or to their environment.

FIG. 8 illustrates an exemplary modular inverter topology 132 that may be employed in the modular inverter 48 illustrated in FIG. 4. The modular inverter 48 includes a plurality of individual inverter modules, generally represented by numerals 134 through 144. Reference numeral 148 represents the input from the power grid 12 from which voltage is fed into the modular inverter 48 via the transformer 38, again having a multi-wound secondary. Each of the inverter modules is rated to operate at a fraction of the voltage from the power grid 12 reducing the switching losses to increase the reliability and allow for the generation of waveforms close to a desired sinusoidal shape to reduce the amount of filter required to eliminate high frequency components.

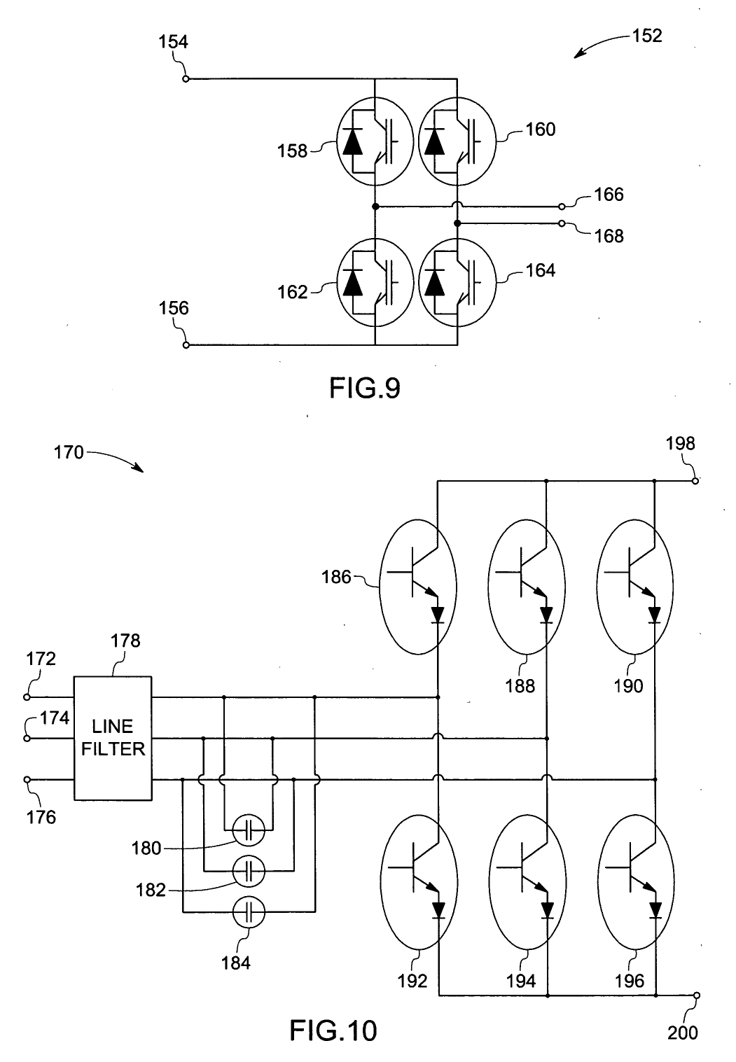

FIG. 9 illustrates an exemplary DC-DC converter topology 152 as used in the DC voltage converters illustrated in FIG. 3, FIG. 4 and FIG. 5. In general, the DC-DC converter 152 accepts a DC input and produces a DC output, there being a difference between the levels of the DC input and the DC output. These types of DC-to-DC converters, which are already known in the art, normally use a single power switch, diodes and reactive components to generate a voltage output larger (Boost converter) or smaller (Buck converter) than the input voltage.

FIG. 10 illustrates an exemplary current source inverter topology 170 for use in the exemplary current source inverter 54 illustrated in FIG. 5. The AC inputs are provided via input terminals designated by numerals 172, 174, and 176. Typically, the voltage inputs are sinusoidal but without any of the high frequency components that would have been present if a voltage source converter would have been used in lieu of the current source inverter. A line filter 178 is utilized to filter harmonics from the current waveform that is typically not sinusoidal, but resembles a square wave unless additional pulse wave modulation of the output current is employed. The line filter 178 has, coupled to it, filter inductors that aid in lowering DC ripple. Capacitors 180, 182, and 184 are coupled between two phase lines of the 3-phase input to help in the current commutation. In the illustrated figure, the switching modules 186 through 196 are each composed of an insulated gate bipolar junction transistor (IGBT) in series with a diode. However, it may be noted that any other power switching device such as integrated gate-commutated thyristors (IGCTs) or bipolar junction transistors (BJTs) may be also used. As will be appreciated by those skilled in the art, these switching modules are configured to operate in reverse blocking mode, the diodes providing the desired reverse blocking. The current source inverter 170 provides a DC voltage output via terminals 198 and 200.

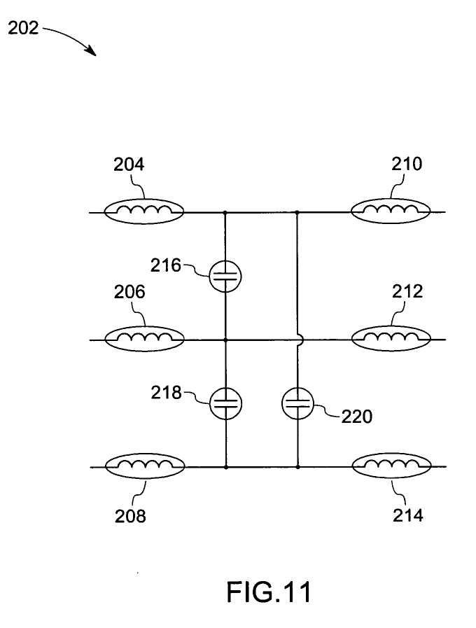

FIG. 11 illustrates an exemplary filter topology 202 used in certain implementations of the present technique. The topology 202 represents a 3-phase LC passive filter that includes inductors 204-214 and capacitors 216-220. As will be appreciated by a person skilled in the art, the order of the filter i.e., first, second or higher order; filter damping and the harmonics that the filter helps eliminate will depend of the required power quality.

According to certain aspects of the present technique, an exemplary method for regulating power in an electrical power transmission and distribution system (the power grid 12 as an illustrative examples of FIGS. 1-5) includes supplying a DC power to a DC load. The DC power may be obtained by transforming AC power drawn from the electrical power transmission and distribution system. The method also involves regulating the power in the system by supplying a controllable reactive power from the DC load to the system, producing useful work by the DC load. In certain exemplary embodiments of the present technique, when the DC load is an electrolyzer, the method also involves producing an amount of hydrogen based upon the supplied controllable reactive power.

The method of regulating power also includes monitoring the electrolyzer for the amount of hydrogen produced. As explained previously, the hydrogen generated by the electrolyzer while regulating power in the system may be utilized for any suitable downstream purpose or application. By way of example only, the hydrogen generated may be utilized to power vehicles, or to generate electricity via fuel cells when power from the grid is temporarily unavailable. It should be particularly noted that such a system when employed in remote locations would allow a power stations that effectively performs its primary function, i.e., regulating power, and also actively sustains the personnel who support the functioning of the power station.

In another aspect of the present technique, the method for regulating electrical power may include converting an AC voltage to a DC voltage using one or more voltage converters (as illustrated in FIG. 1 and FIG. 2). The DC voltage is further provided to an electrolyzer for the production of hydrogen by electrolysis. Furthermore, the method includes controlling the operation of the voltage converters and/or the electrolyzer to regulate the electrical power.

The various exemplary embodiments of the present technique illustrated and described above, as would be appreciated by a person skilled in the art, may be used to provide the power grid 12 with regulated amount of reactive power even when not providing active power to the DC load (which is the electrolyzer in certain exemplary cases). For instance, in certain implementations, the converter connected to the electrolyzer may be disabled. The first converter unit 14 that is connected to the power grid 12 may generate voltages that are always phase-shifted by plus or minus 90 degrees electrical with respect to the output current. The polarity of the phase shift, as specified earlier, may depend on whether capacitive reactive power or inductive reactive power is required. The amplitude of the output current will have to be regulated according to the amount of reactive power to be delivered.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for regulating power in a grid, comprising:
generating a controllable DC power to an electrolyzer via power conversion circuitry to produce hydrogen; and
providing a controllable reactive power to the grid via the power conversion circuitry to regulate power in the grid.

2. The method of claim 1, comprising monitoring the electrolyzer for an amount of hydrogen produced by the electrolyzer.

3. The method of claim 2, comprising controlling operation of the power conversion circuitry via a controller.

4. The method of claim 3, comprising controlling operation of the controller via a remote controller.

5. The method of claim 1, comprising regulating the reactive power in the grid by controlling power factor.

6. The method of claim 1, further comprising temporarily removing or interrupting the electrolyzer while providing the controllable reactive power to the grid via the power conversion circuitry.

7. A method for regulating power, comprising:
converting an alternating current (AC) power to a direct current (DC) power via one or more converters;
using the DC voltage to produce hydrogen by electrolysis; and
generating a controllable reactive power by controlling operation of the one or more converters and the electrolysis to regulate the power.

8. The method of claim 7, further comprising producing the hydrogen via an electrolyzer.

9. The method of claim 8, further comprising monitoring the electrolyzer for the hydrogen produced.

10. The method of claim 7, further comprising remotely monitoring and/or adjusting the regulation of power.

11. The method of claim 7, further comprising interrupting the production of hydrogen while generating the controllable reactive power to regulate the power.

12. A system for regulating power in a grid, comprising:
an electrolyzer for producing hydrogen; and
power conversion circuitry coupled to the grid and the electrolyzer, wherein the power conversion circuitry is adapted to supply a controllable DC power to the electrolyzer and a controllable reactive power to the grid.

13. The system of claim 12, further comprising a controller for monitoring power in the grid.

14. The system of claim 13, wherein the controller is configured to monitor and control the power conversion circuitry, and/or an electrolyzer monitor.

15. The system of claim 13, further comprising a remote controller configured to control and monitor the controller.

16. The system of claim 13, wherein the at least one or more power converters are based on a bulk converter topology, a modular inverter topology or a current-source inverter topology.

17. The system of claim 13, wherein the electrolyzer produces hydrogen based on the controllable reactive power supplied to the grid.

18. The system of claim 13, further comprising a fuel cell assembly configured to use the hydrogen produced by the electrolyzer.

19. The system of claim 13, wherein the power conversion circuitry is configured to filter harmonics from the AC power.

20. The system of claim 18, wherein the power conversion circuitry comprises at least one power converter to convert AC power to a DC power.

21. The system of claim 20, wherein the power conversion circuitry comprises at least one power converter to alter the DC power.

22. The system of claim 18, wherein the power conversion circuitry provides the controllable DC power to the electrolyzer as a controlled current.

23. The system of claim 18, wherein the electrolyzer is monitored for the amount of hydrogen produced.
